(19) United States
(12) Patent Application Publication
(10) Pub. No.: US 2008/0055307 A1
(43) Pub. Date: Mar. 6, 2008

(54) Graphics rendering pipeline

(76) Inventor: Lazar Bivolarski, Cupertino, CA (US)

Correspondence Address: HAVERSTOCK & OWENS LLP, 162 N WOLFE ROAD, SUNNYVALE, CA, 94086, US

(21) Appl. No.: 11/897,734

(22) Filed: Aug. 30, 2007

Related U.S. Application Data
(60) Provisional application No. 60/841,888, filed on Sep. 1, 2006.

(51) Int. Cl. G06T 15/00

(52) U.S. Cl. 345/419

(57) ABSTRACT

A method and system of processing graphics data using fine-grain instruction parallelism is provided. The method includes geometrically processing a three dimensional data set with an integral parallel machine to produce a two dimensional geometry. The integral parallel machine can include a data parallel system and a time parallel system coupled with a memory and an input-output system. The two dimensional geometry can be rendered for reproduction on an imaging apparatus using the data parallel system. The system can comprise an array of processing elements configured for receiving fine-grained instructions. The two dimensional geometry can be mapped into the processing elements. Fine-grain instructions of the processing elements can be used in processing the graphics data and can be stored in instruction sequencers of the processing elements. A diagonal mapping scheme can be use to load the fine-grain instructions in a data memory of the processing elements in a diagonal order.

### RELATED APPLICATION(S)

This Patent Application claims priority under 35 U.S.C. §119(e) of the co-pending, co-owned U.S. Provisional Patent Application No. 60/841,888, filed Sep. 1, 2006, and entitled “INTEGRAL PARALLEL COMPUTATION” which is also hereby incorporated by reference in its entirety.

This Patent Application is related to U.S. patent application Ser. No. ______, entitled “INTEGRAL PARALLEL MACHINE”, [Attorney Docket No. CONX-00101] filed ______, which is also hereby incorporated by reference in its entirety.

### FIELD OF THE INVENTION

The present invention relates to the field of data processing. More specifically, the present invention relates to a three dimensional graphics rendering pipeline using fine-grain instruction parallelism.

### BACKGROUND OF THE INVENTION

Computing workloads in the emerging world of “high definition” digital multimedia (e.g. HDTV and HD-DVD) more closely resembles workloads associated with scientific computing, or so called supercomputing, rather than general purpose personal computing workloads. Unlike traditional supercomputing applications, which are free to trade performance for super-size or super-cost structures, entertainment supercomputing in the rapidly growing digital consumer electronic industry imposes extreme constraints of both size and cost.

With rapid growth has come rapid change in market requirements and industry standards. The traditional approach of implementing highly specialized integrated circuits (ASICs) is no longer cost effective as the research and development required for each new application specific integrated circuit is less likely to be amortized over the ever shortening product life cycle. At the same time, ASIC designers are able to optimize efficiency and cost through judicious use of parallel processing and parallel data paths. An ASIC designer is free to look for explicit and latent parallelism in every nook and cranny of a specific application or algorithm, and then exploit that in circuits. With the growing need for flexibility, however, an embedded parallel computer is needed that finds the optimum balance between all of the available forms of parallelism, yet remains programmable.

Embedded computation requires more generality/flexibility than that offered by an ASIC, but less generality than that offered by a general purpose processor. Therefore, the instruction set architecture of an embedded computer can be optimized for an application domain, yet remain “general purpose” within that domain.

The current implementations of data parallel computing systems use only one *instruction sequencer to send one instruction at a time to an array of processing elements. This results in significantly less than 100% processor utilization, typically closer to the 20%-60% range because many of the processing elements have no data to process or because they have the inappropriate internal state.

In this regard, current systems for three-dimensional graphics rendering require great computational complexity and resources. Accordingly, there is a need for systems and methods for improving the efficiency of such graphics rendering systems.

### SUMMARY OF THE INVENTION

In accordance with a first aspect of the present invention, a method of processing graphics data is provided. A three dimensional data set can be geometrically processed with an integral parallel machine to produce a two dimensional geometry. The integral parallel machine can include a data parallel system and a time parallel system coupled with a memory and an input-output system. The two dimensional geometry can be rendered for reproduction on an imaging apparatus using the data parallel system. The data parallel system can comprise an array of processing elements configured for receiving fine-grained instructions. The two dimensional geometry can be mapped into the array of processing elements.

The three dimensional data set can be generated in an application program interface that is in communication with the integral parallel machine. The generated three dimensional data set can comprise an array of vertex transforms. The data parallel system can generate a vertex data set of graphic primitives of the three dimensional data set. The vertex data set can include geometry data, light source data, and texture data. The array of processing elements can be used to produce the two dimensional geometry. A plurality of fine-grain instructions of the array of processing elements can be used in processing the graphics data. The plurality of fine-grained instructions can be stored in a plurality of instruction sequencers coupled with the array of processing elements.

In accordance with another aspect of the present invention, a method of processing graphics data is provided. A three dimensional data set can be generated in an application program interface that is in communication with an integral parallel machine graphics processor. The generated three dimensional data set can comprise an array of vertex transforms. A geometry of the three dimensional data set can be transformed into a two dimensional geometry using an array of processing elements of a data parallel system of the integral parallel machine. A plurality of fine-grained instructions of the array of processing elements can be used in transforming of the three dimensional data set. The data parallel system can generate a vertex data set of graphic primitives of the three dimensional data set. The vertex data set can include geometry data, light source data, and texture data. The two dimensional geometry can be rasterized using a time parallel system of the integral parallel system. The rasterizing step can further comprise mapping the two dimensional geometry into the array of processing elements of the data parallel system. Three dimensional image data can be mapped into an array of processing elements of the data parallel system for reproduction on an imaging device. A diagonal mapping scheme can be use to load the plurality of fine-grain instructions in a data memory of the processing elements in a diagonal order.

In accordance with another aspect of the present invention, a system for graphics data processing is provided. The system includes a data parallel system for performing parallel data computations. The data parallel system can comprise a fine-grain data parallelism architecture for processing graphics data. The data parallel system includes an array of processing elements. A plurality of sequencers are coupled to the array of processing elements for providing and sending a plurality of instructions to associated processing elements within the array of processing elements. A direct memory access component is coupled to the array of processing elements for transferring the data to and from a memory. Further, a selection mechanism is coupled to the plurality of sequencers. The plurality of sequencers includes fine-grain instructions for processing the graphics data. The selection mechanism is configured to select the associated processing elements. A diagonal mapping scheme can be use to load the plurality of fine-grain instructions in a data memory of the processing elements in a diagonal order.

Other objects and features of the present invention will become apparent from consideration of the following description taken in conjunction with the accompanying drawings.

### BRIEF DESCRIPTION OF THE DRAWINGS

FIG. 1 illustrates a block diagram of an integral parallel machine for processing compressed multimedia data using fine grain parallelism according to an aspect of the present invention.

FIG. 2A illustrates a block diagram of a linear time parallel system.

FIG. 2B illustrates a block diagram of a looped time parallel system.

FIG. 3 illustrates a block diagram of a data parallel system including a fine-grain instruction parallelism architecture according to another aspect of the current invention.

FIG. 4 illustrates a functional block diagram of a system of a graphics rendering pipeline according to the present invention.

FIG. 5 illustrates a functional block diagram of a system of a three dimensional graphics rendering pipeline with the graphics processor shown in greater detail according to an embodiment of the present invention.

FIG. 6 illustrates a flowchart of a method of a three dimensional graphics rendering pipeline according to an embodiment of the present invention.

### DETAILED DESCRIPTION OF THE PREFERRED EMBODIMENT

The present invention maximizes the use of processing elements (PEs) in an array for data parallel processing. In previous implementations of PEs with one sequencer, occasionally the degree of parallelism was small, and many of the PEs were not used. The present invention employs multiple sequencers to enable more efficient use of the PEs in the array. Each instruction sequencer used to drive the array issues an instruction to be executed only by selected PEs. By utilizing multiple sequencers, two or more streams of instructions can be broadcast into the array and multiple programs are able to be processed simultaneously, one for each instruction sequencer.

An Integral Parallel Machine (IPM) incorporates data parallelism, time parallelism and speculative parallelism but separates or segregates each. In particular, data parallelism and time parallelism are separated with speculative parallelism in each. The mixture of the different kinds of parallelism is useful in cases that require multiple kinds of parallelism for efficient processing.

An example of an application for which the different kinds of parallelism are required but are preferably separated is a sequential function. Some functions are pure sequential functions such as f(h(x)). The important aspect of a pure sequential function is that it is impossible to compute f before computing h since f is reliant on h. For such functions, time parallelism can be used to enhance efficiency which becomes very crucial. By understanding that it is possible to turn a sequential pipe into a parallel processor, a pipeline of sequential machines can be used to compute sequential functions very efficiently.

For example, two machines in sequence are used to compute f(h(x)). The machines include a first machine computing h is coupled to a second machine computing f. A stream of operands, x₁, x₂, . . . xₙ, is processed such that h(x₁) is processed by the first machine while the second machine computing f performs no operation in the first clock cycle. Then, in the second clock cycle, h(x₂) is processed by the first machine, and f(h(x₁)) is processed by the second machine. In the third clock cycle, h(x₃) is processed while f(h(x₂)) is processed. The process continues until f(h(xₙ)) is computed. Thus, aside from a small latency required to fill the pipeline (a latency of two in the above example), the pipeline is able to perform computations in parallel for a sequential function and produce a result in each clock cycle, thereafter.

For a set of sequential machines to work properly as a parallel machine, the set preferably functions without interruption. Therefore, when confronted with a situation such as:

c=c[0]?c+(a+b):c+(a−b),

not only is time parallelism important but speculative parallelism is as well. The code above is interpreted to mean that if a Least Significant Bit (LSB) of c is 1, then set c equal to c+(a+b), but if the LSB of c is 0, then set c equal to c+(a−b). Typically, the value of c is determined first to find out if it is a 0 or 1, and then depending on the value of c, b would either be added to a, or b would be subtracted from a. However, by performing the functions in such an order would cause an interruption in the process as there would be a delay waiting to determine the value of c to determine which branch to take. This would not be an efficient parallel system. If clock cycles are wasted waiting for a result, the system is no longer functioning in parallel at that point. The solution to this problem is referred to as speculative parallelism. Both a+b and a−b are calculated by a machine in the set of machines, and then the value of c is used to select the proper result after they are both computed. Thus, there is no time spent waiting, and the sequence continues to be processed in parallel.

To implement a sequential pipeline to perform computations in parallel, each processing element in a sequential pipeline is able to take data from any of the previous processing elements. Therefore, going back to the example of using c[0] to determine a+b or a−b, in a sequence of processing elements, a first processing element stores the data of c[0]. A second processing element computes c+(a+b). A third processing element computes c+(a−b). A fourth processing element takes the proper value from either the second or third processing element depending on the value of c[0]. Thus, the second and third processing elements are able to utilize the information received from the first processing element to perform their computations. Furthermore, the fourth processing element is able to utilize information from the second and third processing elements to make its computation or selection.

To select previous processing elements, preferably a selector/multiplexer is used, although in some embodiments, other mechanisms are implemented. In an alternative embodiment, a file register is used. Preferably, it is possible to choose from 8 previous processing elements, although fewer or more processing elements are possible.

The following is a description of the components of the IPM. A memory is used to store data and programs and to organize interface buffers between all sub-systems. Preferably, a portion of the memory is on chip, and a portion of it is on external RAM. An input-output system includes general purpose interfaces and, if desired, application specific interfaces. A host is one or more general purpose controllers used to control the interaction with the external world or to run sequential operations that are neither data intensive nor time intensive. A data parallel system is an array of processing elements interconnected by a simple network. A time parallel system with speculative capabilities is a dynamically reconfigurable pipe of processing elements. In each clock cycle, new data is inserted into the pipe of processing elements. In a pipe with n blocks, it is possible to do n computations in parallel. As described above there is an initial latency, but with a large amount of data, the latency is negligible. After the latency period, each clock cycle produces a single result.

The IPM is a “data-centric” design. This is in contrast with most general purpose high-performance sequential machines, which tend to be “program-centric.” The IPM is organized around the memory in order to have maximum flexibility in partitioning the overall computation into tasks performed by different complementary resources.

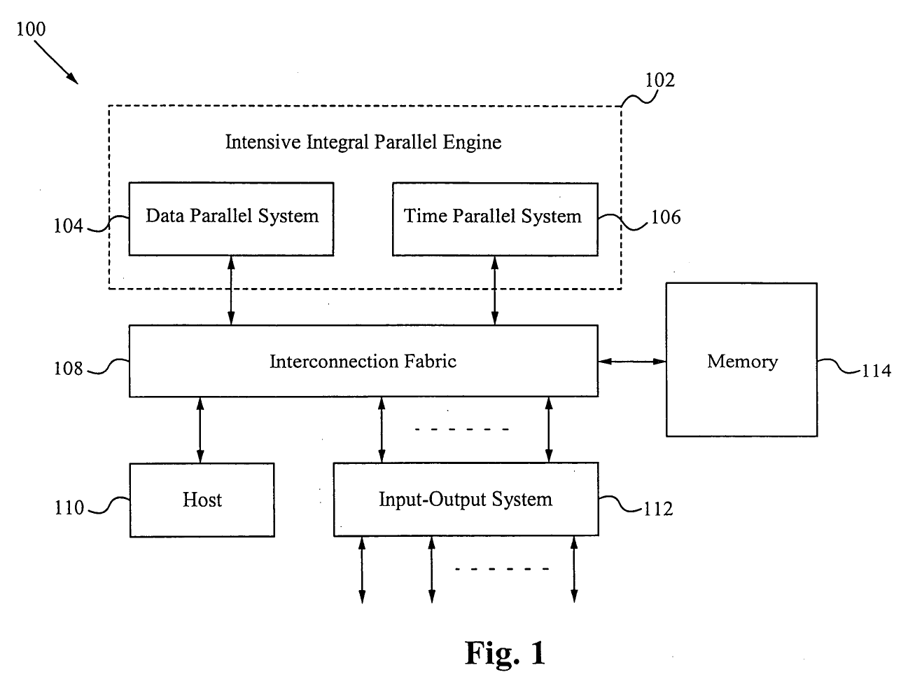

FIG. 1 illustrates a block diagram of an Integral Parallel Machine (IPM) 100. The IPM 100 is a system for multimedia data processing. The IPM 100 includes an intensive integral parallel engine 102, an interconnection fabric 108, a host 110, an Input-Output (I/O) system 112 and a memory 114. The intensive integral parallel engine 102 is the core containing the parallel computational resources. The intensive integral parallel engine 102 implements the three forms of parallelism (data, time and speculative) segregated in two subsystems—a data parallel system 104 and a time parallel system 106.

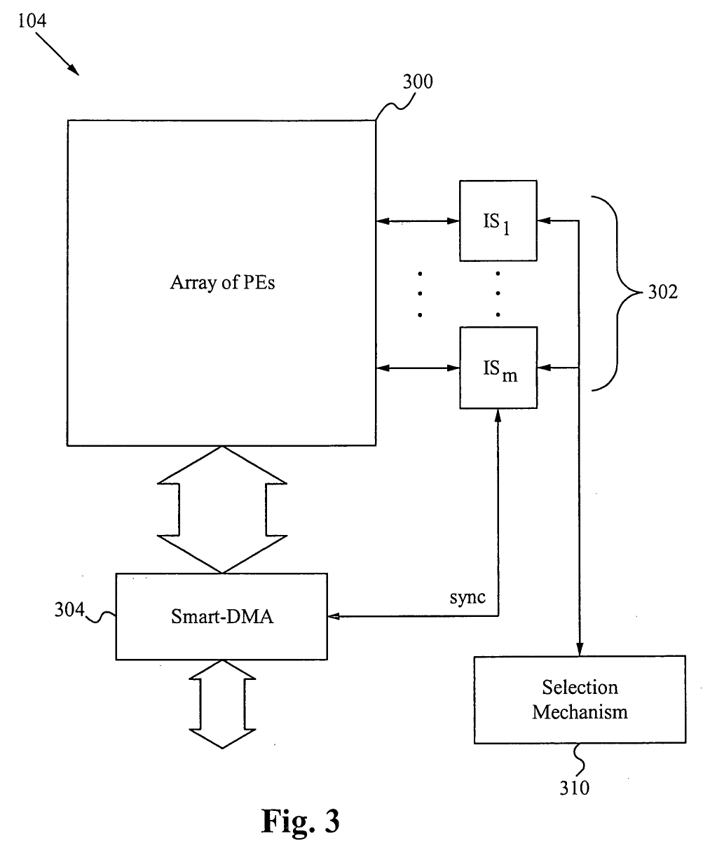

The data parallel system 104 is an array of processing elements interconnected by a simple network. The data parallel system 104 issues, in each clock cycle, multiple instructions. The instructions are broadcast into the array for performing a function as will be described herein below in reference to FIG. 3. Related data parallel systems are described further in U.S. Pat. No. 7,107,478, entitled DATA PROCESSING SYSTEM HAVING A CARTESIAN CONTROLLER, and U.S. Patent Publ. No. 2004/0123071, entitled CELLULAR ENGINE FOR A DATA PROCESSING SYSTEM, which are hereby incorporated by reference in their entirety.

The time parallel system 106 is a dynamically reconfigurable pipe of processing elements. Each processing element in the data parallel system 104 and the time parallel system 106 is individually programmable.

The memory 114 is used to store data and programs and to organize interface buffers between all of the sub-systems. The I/O system 112 includes general purpose interfaces and, if desired, application specific interfaces. The host 110 is one or more general purpose controllers used to control the interaction with the external world or to run sequential operations that are neither data intensive nor time intensive.

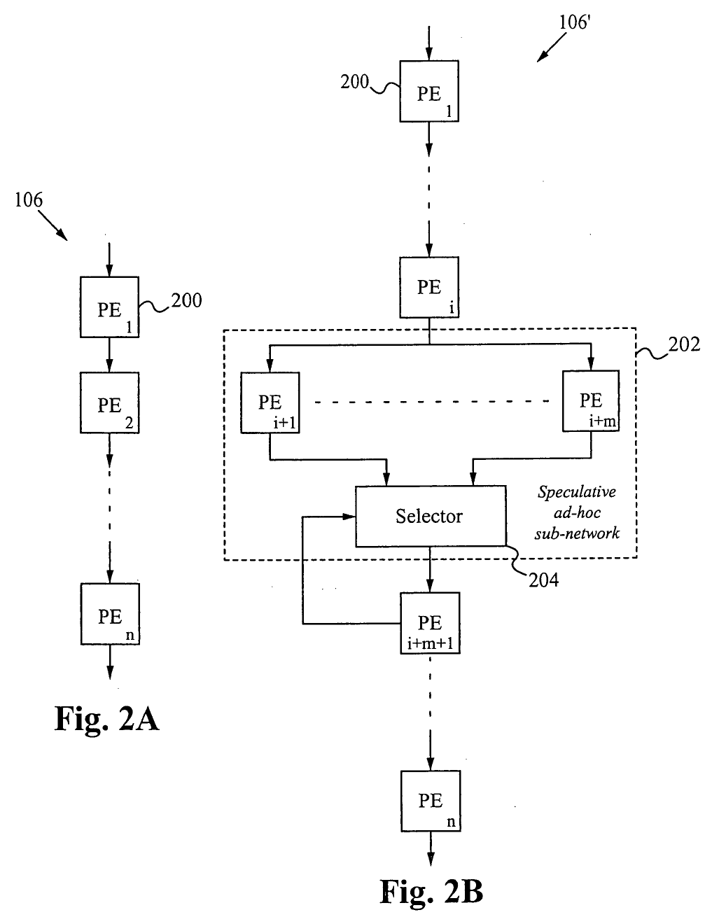

FIG. 2A illustrates a block diagram of a linear time parallel system 106. The linear time parallel system 106 is a line of processing elements 200. In each clock cycle, new data is inserted. Since there are n blocks, it is possible to do n computations in parallel. As described above, there is an initial latency, but typically the latency is negligible. After the latency period, each clock cycle produces a single result. The time parallel system 106 is a dynamically configurable system. Thus, the linear pipe can be reconfigured at the clock cycle level in order to provide “cross configuration” as is shown in FIG. 2B.

As described above, each processing element 200 is able to be configured to perform a specified function. Information, such as a stream of data, enters the time parallel system 106 at the first processing element, PE₁, and is processed in a first clock cycle. In a second clock cycle, the result of PE₁ is sent to PE₂, and PE₂ performs a function on the result while PE₁ receives new data and performs a function on the new data. The process continues until the data is processed by each processing element. Final results are obtained after the data is processed by PEₙ.

FIG. 2B illustrates a block diagram of a looped time parallel system 106′. The looped time parallel system 106′ is similar to the linear time parallel system 106 with a speculative sub-network 202. To efficiently enable more complex processing of data including computing branches such as c=c[0]?c+(a+b):c+(a−b), the speculative sub-network 202 is used. A selection component 204 such as a selector, multiplexor or file register is used to provide speculative parallelism. The selection component 204 allows a processing element 200 to select input data from a previous processing element that is included in the speculative sub-network 202.

FIG. 3 illustrates a block diagram of a data parallel system 104. The data parallel system 104 comprises a fine-grain instruction parallelism architecture for decoding compressed multimedia data. Fine-grain parallelism comprises processes typically small ranging from a few to a few hundred instructions. The data parallel system 104 includes an array of processing elements 300, a plurality of instruction sequencers 302 coupled to the array of processing elements 300, a Smart-DMA 304 coupled to the array of processing elements 300, and a selection mechanism 310 coupled to the plurality of instruction sequencers 302. The processing elements 300 in the array each execute an instruction broadcasted by the plurality of instruction sequencers 302. The processing elements of the array of processing elements 300 can be individually programmable. The instruction sequencers 302 each generate an instruction each clock cycle. The instruction sequencers 302 provide and send the generated instruction to associated processing elements within the array 300. The plurality of sequencers 302 can comprise fine-grain instructions for decoding the compressed multimedia data. Each of the plurality of sequencers 302 can comprise a unique and an independent instruction set. The instruction sequencers 302 also interact with the Smart-DMA 304. The Smart-DMA 304 is an I/O machine used to transfer data between the array of processing elements 300 and the rest of the system. Specifically, the Smart-DMA 304 transfers the data to and from the memory 114 (FIG. 1). The selection mechanism 310 is configured to select the associated processing elements of the array of processing elements 300. The associated processing elements can be selected using a selection instruction of the selection mechanism 310.

Within the data parallel system several design elements are preferred. Strong data locality of algorithms allows processing elements to be coupled in a compact linear array with nearest neighbor connections. The number of 16-bit processing elements is preferably between 256 and 1024. Each processing element contains a 16-bit ALU, an 8-word register file, a 256-word data memory and a boolean machine with an associated 8-bit state register. Since cycle operations are ADD and SUBTRACT on 16-bit integers, a small number of additional single-clock instructions support efficient (multi-cycle) multiplication. The I/O is a 2-D network of shift registers with one register per processing element for performing a SHIFT function. Two or more independent (stack-based) instruction sequencers including one or more 32-bit instruction sequencers that sequence arithmetic and logic instructions into the array of processing elements and a 32/128-bit stack-based I/O controller (or “Smart-DMA”) are used to transfer data between an I/O plan and the rest of the system which results in a Single Instruction Multiple Data (SIMD)-like machine for one instruction sequencer or a Multiple Instruction Multiple Data (MIMD) of SIMD machine for more than one instruction register. A Smart-DMA and the instruction sequencer communicate with each other using interrupts. Data exchange between the array of the processing elements and the I/O is executed in one clock cycle and is synchronized using a sequence of interrupts specific to each kind of transfer. An instruction sequencer instruction is conditionally executed in each processing element depending on a boolean test of the appropriate bit in the state register.

Each processing element also receives data decoded from the multimedia data stream. Therefore, n processing elements process a function each clock cycle. The transferring or sending of the instructions from the plurality of sequencers 302 to the associated processing elements uses a diagonal mapping scheme. This diagonal mapping scheme loads a data memory of the processing elements in a diagonal order. Loading the data memory of the processing elements in a diagonal order provides a saving in data memory resources and increases efficiency of data transferring data and instructions to the processing elements.

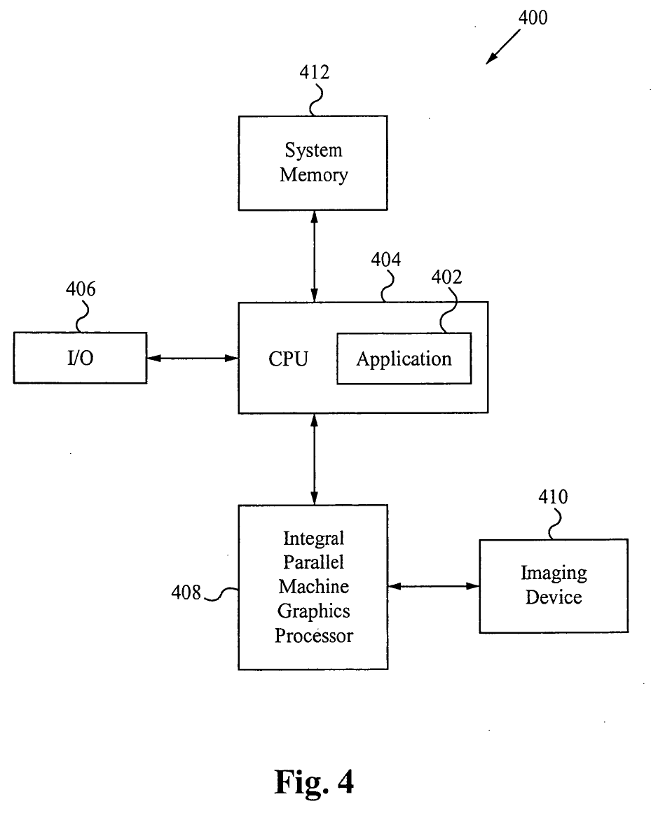

FIG. 4 illustrates a functional block diagram of a system 400 of a graphics rendering pipeline according to the present invention. The system 400 can be used in rendering three dimensional computer graphics as two dimensional graphics. The system 400 generally comprises an application process 402, a main processor 404, an I/O device 406, an integral parallel machine graphics processor 408 and an imaging device 410. The system 400 can include a system memory 412. Conventionally, the three dimensional computer graphics are eventually displayed on a computer monitor or imaging device 410. The application process 402 can comprise a three-dimensional application program. Such three-dimensional application are in use by many sectors of industry including those specializing in video games, medicine, entertainment and engineering. The application process 402 can contain a three dimensional scene including various three dimensional models and figures. The main processor 404 converts the three dimensional models into geometric primitives and vertices for input to the graphics processor 408. The main processor 404 can include and application program interface (API) configured for generating the geographic primitives and vertices. The graphic processor 408 is configured for processing the geometric primitives and vertices to produce two dimensional image data for display on the imaging device 410.

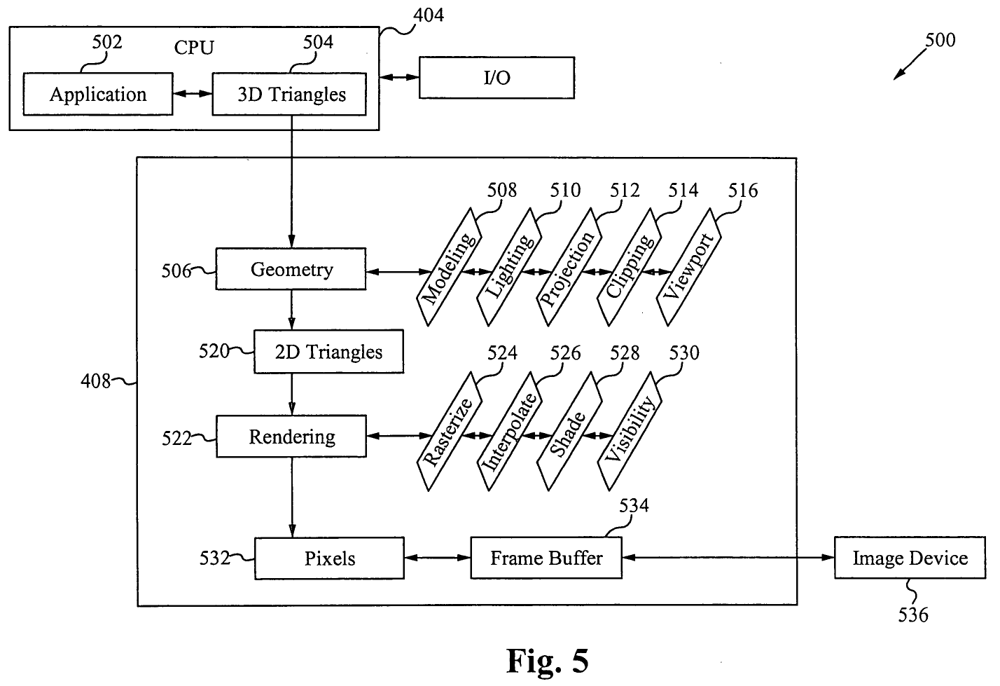

FIG. 5 illustrates a functional block diagram of a system 500 of a three dimensional graphics rendering pipeline with the graphics processor 408 shown in greater detail according to an embodiment of the present invention. The graphics processor 408 can comprise an architecture similar to the integral parallel machine 102 (FIG. 1). The graphics processor 408 can include a plurality of logic sections that compute different functions of the rendering of computer graphics. The logic sections can include a geometry logic 506 and a rendering logic 522. The graphics processor 408 can further include logic sections of a 2D triangles logic 520 and a pixies logic 532. The system 500 can include the processes of an application 502 and a 3D triangles 504.

The application 502 can contain the three dimensional scene including the various three dimensional models and figures. The application 502 can be stored in system memory 402 and can be executed on the main processor 404. The three dimensional scene can be represented as polygons. The polygons are typically represented as a collection of triangles. The triangles can be represented by three vertices. Each vertex can be represented by a three coordinate vector. The application 502 can include additional information describing the three dimensional scene such as lighting and textures. The application 502 can also include transformation information that can be used to convert the three dimensional models from a conceptual model space to a camera space.

The 3D triangles logic 504 is a process for converting the three dimensional information into basic geometric primitives and vertices for the geometry logic 506. The 3D triangles logic 504 like the application logic 502 can be configured for execution on the main processor 404. The geometric primitives include triangles, points and lines, and can be received from the application 502.

The geometry logic 506 receives the geometric primitives from the 3D triangles logic 504. The geometry logic 506 comprises a plurality logic sections including a modeling logic 508, a lighting logic 510, a projection logic 512 and a clipping logic 514. The geometry logic 506 can also include a viewport logic 516. The modeling logic 508 can reorient a 3D graphic from the conceptual model space to the camera space by computing a transform of the 3D graphic. For example, the type of transforms can include translation, rotation and scaling. The lighting logic 510 can generate lighting effects for the models and objects in the three dimensional scene. The projection logic 512 can be used to transform the 3D graphic to a 2D graphic representation. A type of projection is orthographic projection that removes the z coordinate from 3D vertices that have been transformed. Another type of projection and more useful is perspective projection since objects appear as in the real world with distant objects appearing smaller than objects close to the viewer. The clipping logic 514 can be used to truncate or remove models and other primitives that will not be visible within the camera space. The clipping logic 514 facilitates acceleration of the rendering logic 522 processes that will be described in detail below, the acceleration is facilitated by eliminating a need to process the removed objects and primitives. The viewport logic 516 can enable generation of different views points of the camera space at the same time.

The 2D triangles logic 520 is an output of the geometry logic 506. The 2D triangles logic 520 includes information configured to be processed by the rendering logic 522. The 2D triangles logic 520 includes list of vertices for each of the triangles or other polygons in a two dimensional representation. The list of vertices describe the models and figures of the three dimensional scene. The triangles logic 520 can also generate the triangles and polygons as arrays of vertices.

The rendering logic 522 is configured to receive the list of vertices from the 2D triangles logic 520. The rendering logic 522 performs operations on the received list of vertices that define the two dimensional representation and converts the list of vertices into a raster format. The rendering logic 522 can generally comprise a rasterize logic 524, an interpolate logic 526 and a shade logic 528. The rendering logic 522 can also include a visibility logic 530. The rasterize logic 524 can determine the presence of primitives in each of the triangles defined by the list of vertices. The rasterize logic 524 can also determine the pixels within the triangles. The interpolate logic 526 can determine a color of a triangle by first computing a color of each of the vertices defining the triangle. The color of a face of the triangle can then be determined by interpolating or blending the color of the face from the color of each vertex. The shade logic 528 can determine a shading value for a face of a triangle or primitive. The shade logic 528 can implement an algorithm called Gouraud shading. In Gouraud shading, the face shading value can be determined by computing a shading value for the vertices of the triangle and interpolating the shading value between the vertices' shading value. The visibility logic 530 can determine the visibility, also known as Z-buffering, of each as pixel in a rendered scene. The visibility logic 530 gives a depth value to each pixel during rasterization. The visibility logic 530 can compare a triangle's pixels depth value to a depth value for the pixels of the scene coinciding with the triangle.

The rendering logic 522 can include a texture logic (not shown) that can determine a texture value for a face of a triangle or primitive. The texture logic (not shown) can determine the face texture value by computing a texture value for the vertices of the triangle and interpolating the texture value between the vertices' texture value. A pixels logic 532 can couple image information of the rendering logic 522 to the imaging device 536. A frame buffer logic 534 can facilitate transfer of the image information to the imaging device 536. The frame buffer logic 534 can include logic for rasterizing a front and rear image of the imaging device 536. The frame buffer logic 534 can also include a frame buffer control logic (not shown). The frame buffer control logic (not shown) can facilitate an efficient transfer of the image information to the imaging device 536. The image information can comprise a 2D raster image that is displayed on the imaging device 536. The imaging device 536 can comprise a computer monitor or other displays devices such as flat screen televisions, PDAs or cell phones.

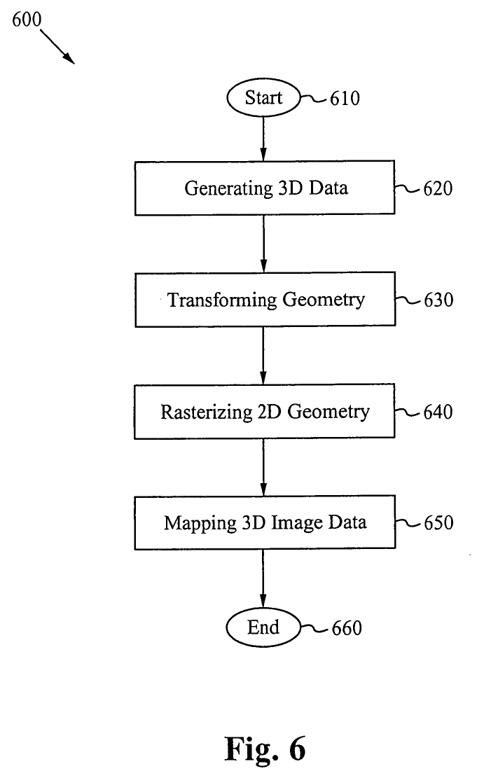

FIG. 6 illustrates a flowchart of a method of a three dimensional graphics rendering pipeline according to an embodiment of the present invention. The method 600 starts at the step 610. In the step 620, a three dimensional data set can be generated in an application program interface that is in communication with an integral parallel machine graphics processor. The generated three dimensional data set can comprise an array of vertex transforms. In the step 630, a geometry of the three dimensional data set can be transformed into a two dimensional geometry using an array of processing elements of a data parallel system of the integral parallel machine. A plurality of fine-grained instructions of the array of processing elements can be used in transforming of the three dimensional data set. The data parallel system can generate a vertex data set of graphic primitives of the three dimensional data set. The vertex data set can include geometry data, light source data, and texture data. In the step 640, the two dimensional geometry can be rasterized using a time parallel system of the integral parallel system. The rasterizing step can further comprise mapping the two dimensional geometry into the array of processing elements of the data parallel system. In the step 650, three dimensional image data can be mapped into an array of processing elements of the data parallel system for reproduction on an imaging device. The method 600 can include a diagonal mapping scheme, which loads the plurality of fine-grain instructions in a data memory of the processing elements in a diagonal order.

In operation, the present invention is able to be used independently or as an accelerator for a standard computing device. By separating data parallelism and time parallelism, processing data with certain conditions is improved. Specifically, large quantities of data such as video processing benefit from the present invention.

Although single pipelines have been illustrated and described above, multiple pipelines are possible. For multiple bitwise data, multiple stacks of these columns or pipelines of processing elements are used. For example, for 16 bitwise data, 16 columns of processing elements are used.

Additionally, although it is described that each processing element produces a result in one clock cycle, it is possible for each processing element to produce a result in any number of clock cycles such as 4 or 8.

There are many uses for the present invention, in particular where large amounts of data is processed. The present invention is very efficient when processing long streams of data such as in graphics and video processing, for example HDTV and HD-DVD.

The present invention has been described in terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications may be made in the embodiment chosen for illustration without departing from the spirit and scope of the invention as defined by the claims.

What is claimed is:

1. A method of processing graphics data comprising:
geometrically processing a three dimensional data set with an integral parallel machine to produce a two dimensional geometry, the integral parallel machine including a data parallel system and a time parallel system coupled with a memory and an input-output system; and
rendering the two dimensional geometry for reproduction on an imaging apparatus using the data parallel system, the data parallel system comprising an array of processing elements configured for receiving fine-grained instructions.

2. The method of claim 1, further comprising generating the three dimensional data set in an application program interface that is in communication with the integral parallel machine.

3. The method of claim 2, wherein the generated three dimensional data set comprises an array of vertex transforms.

4. The method of claim 1, further comprising using the array of processing elements to produce the two dimensional geometry.

5. The method of claim 1, wherein rendering the two dimensional geometry includes mapping the two dimensional geometry into the array of processing elements.

6. The method of claim 1, wherein the data parallel system generates a vertex data set of graphic primitives of the three dimensional data set.

7. The method of claim 6, wherein the vertex data set includes geometry data, light source data, and texture data.

8. The method of claim 1, wherein a plurality of fine-grain instructions of the array of processing elements is used in processing the graphics data.

9. The method of claim 8, wherein the plurality of fine-grained instructions are stored in a plurality of instruction sequencers coupled with the array of processing elements.

10. A method of processing graphics data comprising:
generating a three dimensional data set in an application program interface that is in communication with an integral parallel machine;
transforming a geometry of the three dimensional data set into a two dimensional geometry using an array of processing elements of a data parallel system of the integral parallel machine;
rasterizing the two dimensional geometry using a time parallel system of the integral parallel system; and
mapping three dimensional image data into an array of processing elements of the data parallel system for reproduction on an imaging device.

11. The method of claim 10, wherein the generated three dimensional data set comprises an array of vertex transforms.

12. The method of claim 10, wherein the data parallel system generates a vertex data set of graphic primitives of the three dimensional data set.

13. The method of claim 12, wherein the vertex data set includes geometry data, light source data, and texture data.

14. The method of claim 10, wherein the rasterizing step further comprises mapping the two dimensional geometry into the array of processing elements of the data parallel system.

15. The method of claim 10, wherein a plurality of fine-grain instructions of the array of processing elements is loaded in a data memory of the processing elements in a diagonal order.

16. The method of claim 15, wherein the plurality of fine-grained instructions are stored in a plurality of instruction sequencers coupled with the array of processing elements.

17. A system for graphics data processing comprising:
a data parallel system for performing parallel data computations,
wherein the data parallel system comprises a fine-grain data parallelism architecture for processing graphics data.

18. The system of claim 17, wherein the data parallel system further comprises:
a. an array of processing elements;
b. a plurality of sequencers coupled to the array of processing elements for providing and sending a plurality of instructions to associated processing elements within the array of processing elements;
c. a direct memory access component coupled to the array of processing elements for transferring the data to and from a memory; and
d. a selection mechanism coupled to the plurality of sequencers,
wherein the plurality of sequencers comprise fine-grain instructions for processing graphics data, wherein the selection mechanism is configured to select the associated processing elements.

19. The system of claim 18, wherein the sending of the plurality of instructions to the associated processing elements uses a diagonal mapping scheme.

20. The system of claim 19, wherein the diagonal mapping scheme is configured to load a data memory of the processing elements in a diagonal order.

21. The system of claim 18, wherein the instructions of the plurality of sequencers comprise common functional fine-grain instructions for processing the graphics data.

22. The system of claim 18, wherein the processing elements of the array of processing elements are individually programmable.

23. The system of claim 18, wherein each of the plurality of sequencers comprises a unique instruction set.

24. The system of claim 18, wherein each of the plurality of sequencers comprises an independent instruction set.
